(19) United States
(12) Patent Application Publication
(10) Pub. No.: US 2020/0301207 A1
(43) Pub. Date: Sep. 24, 2020

(54) OPTICAL MEMBER, BACKLIGHT UNIT USING SAID OPTICAL MEMBER, AND LIQUID CRYSTAL DISPLAY DEVICE

(71) Applicant: NITTO DENKO CORPORATION, Ibaraki-shi, Osaka (JP)

(72) Inventors: Takahiro Yoshikawa, Ibaraki-shi (JP); Kozo Nakamura, Ibaraki-shi (JP); Kazuhito Hosokawa, Ibaraki-shi (JP)

(73) Assignee: NITTO DENKO CORPORATION, Ibaraki-shi, Osaka (JP)

(21) Appl. No.: 16/085,836

(22) PCT Filed: Mar. 15, 2017
(86) PCT No.: PCT/JP2017/010352

§ 371 Date: Sep. 17, 2018

(30) Foreign Application Priority Data
Mar. 18, 2016 (JP) 2016-056173

(51) Int. Cl. G02F 1/13357; C09K 11/02; C09K 11/08; C09K 11/70; C09K 11/61; G02F 1/1335; F21V 8/00

(52) U.S. Cl. CPC G02F 1/133617; C09K 11/02; C09K 11/0883; B82Y 20/00; C09K 11/617; G02F 1/133536; G02B 6/0053; C09K 11/70

(57) ABSTRACT

An optical member is disclosed that can achieve a liquid crystal display apparatus having excellent durability and having a high color rendering property. An optical member according to the present invention includes, in the stated order: a first barrier layer; a wavelength conversion layer; and a second barrier layer. The wavelength conversion layer includes a matrix and a wavelength conversion material dispersed in the matrix. An emission spectrum of light to be extracted from the optical member has a peak having an intensity Gp in a wavelength band of from 515 nm to 550 nm, and a peak having an intensity Rp in a wavelength band of from 605 nm to 650 nm, and an average value Ave of intensities in a wavelength band of from 570 nm to 600 nm in the emission spectrum and an average value of Gp and Rp satisfy the following expression (1):

Ave≤0.1×{(Gp+Rp)/2} (1).

### TECHNICAL FIELD

The present invention relates to an optical member, a backlight unit, and a liquid crystal display apparatus. More specifically, the present invention relates to an optical member including a wavelength conversion layer capable of extracting light having a specific emission spectrum, and a backlight unit and a liquid crystal display apparatus each using the optical member.

### BACKGROUND ART

As a low-power-consuming and space-saving image display apparatus, a liquid crystal display apparatus enjoys remarkably widespread use. Along with the widespread use of the liquid crystal display apparatus, there is a continuous demand for thinning, increase in size, and higher resolution of the liquid crystal display apparatus. Further, in recent years, there has been an increasing demand for higher color rendering (wider color gamut) of the liquid crystal display apparatus. As a technology aimed at higher color rendering, there are given, for example, a technology using LED light sources of three colors, i.e., red (R), green (G), and blue (B), and a technology combining a blue or ultraviolet LED and a wavelength conversion material. However, with any of those technologies, it is difficult to achieve the desired higher color rendering (wider color gamut), and hence a further improvement is demanded. In addition, there is a proposal of a technology involving incorporating a phosphor into a pressure-sensitive adhesive, and causing a color in a visible light region to be displayed through the use of UV light (Patent Literature 1). However, the phosphor is liable to be deteriorated due to water vapor and/or oxygen, and hence the technology described in Patent Literature 1 is extremely insufficient in terms of durability. Further, in the technology, such heat resistance as to prevent deterioration due to heat of a backlight is demanded.

### CITATION LIST

### Patent Literature

[PTL 1] JP 09-176590 A

### SUMMARY OF INVENTION

### Technical Problem

The present invention has been made in order to solve the problem of the related art described above, and an object of the present invention is to provide an optical member that can achieve a liquid crystal display apparatus having excellent durability and having a high color rendering property.

### Solution to Problem

An optical member according to an embodiment of the present invention includes, in the stated order: a first barrier layer; a wavelength conversion layer; and a second barrier layer. The wavelength conversion layer includes a matrix and a wavelength conversion material dispersed in the matrix. An emission spectrum of light to be extracted from the optical member has a peak having an intensity Gp in a wavelength band of from 515 nm to 550 nm, and a peak having an intensity Rp in a wavelength band of from 605 nm to 650 nm, and an average value Ave of intensities in a wavelength band of from 570 nm to 600 nm in the emission spectrum and an average value of Gp and Rp satisfy the following expression (1):

Ave≤0.1×{(Gp+Rp)/2} (1).

In one embodiment of the present invention, the matrix includes a resin film. In another embodiment of the present invention, the matrix includes a pressure-sensitive adhesive, and the first barrier layer or the second barrier layer is omitted.

In one embodiment of the present invention, the wavelength conversion material includes a first wavelength conversion material having a center emission wavelength in the wavelength band ranging from 515 nm to 550 nm and a second wavelength conversion material having a center emission wavelength in the wavelength band ranging from 605 nm to 650 nm.

In one embodiment of the present invention, the first wavelength conversion material and the second wavelength conversion material each include quantum dots. In another embodiment of the present invention, the first wavelength conversion material includes quantum dots, and the second wavelength conversion material includes a phosphor. In still another embodiment of the present invention, the first wavelength conversion material and the second wavelength conversion material each include a phosphor.

In one embodiment of the present invention, the optical member further includes a reflective polarizer on an outer side of the first barrier layer or the second barrier layer.

In one embodiment of the present invention, the optical member further includes a low-refractive index layer, which has a refractive index of 1.30 or less, between the reflective polarizer and the first barrier layer or the second barrier layer.

In one embodiment of the present invention, the optical member further includes at least one prism sheet between the reflective polarizer and the first barrier layer or the second barrier layer.

In one embodiment of the present invention, the optical member further includes a polarizing plate, which includes an absorption-type polarizer, on an opposite side of the reflective polarizer to the first barrier layer or the second barrier layer.

According to another aspect of the present invention, there is provided a backlight unit. The backlight unit includes: a light source; and the optical member as described above, which is arranged on a viewer side of the light source.

In one embodiment of the present invention, the light source is configured to emit light in a blue to ultraviolet region.

According to still another aspect of the present invention, there is provided a liquid crystal display apparatus. The liquid crystal display apparatus includes: a liquid crystal cell; a viewer side polarizing plate, which is arranged on a viewer side of the liquid crystal cell; a back-surface side polarizing plate, which is arranged on an opposite side of the liquid crystal cell to the viewer side; and the optical member as described above, which is arranged on an outer side of the back-surface side polarizing plate.

A liquid crystal display apparatus according to another embodiment of the present invention includes: a liquid crystal cell; a viewer side polarizing plate, which is arranged on a viewer side of the liquid crystal cell; and the optical member as described above, which is arranged on an opposite side of the liquid crystal cell to the viewer side.

### Advantageous Effects of Invention

According to the present invention, the wavelength conversion layer configured to be capable of extracting light having a specific emission spectrum is sandwiched between the barrier layers, and thus the optical member that can achieve a liquid crystal display apparatus having excellent durability and having a high color rendering property can be obtained. Further, when the wavelength conversion layer is sandwiched between the barrier layers to form a sheet, a distance between a position at which the sheet is arranged and alight source is increased, and hence an optical member stable also from the viewpoint of heat resistance can be achieved.

### BRIEF DESCRIPTION OF DRAWINGS

FIG. 1 is a schematic cross-sectional view for illustrating an optical member according to one embodiment of the present invention.

FIG. 2 is a graph for schematically showing an example of the emission spectrum of light to be extracted from an optical member according to the embodiment of the present invention.

FIG. 3 is a schematic cross-sectional view for illustrating an optical member according to another embodiment of the present invention.

FIG. 4 is a schematic cross-sectional view for illustrating an optical member according to still another embodiment of the present invention.

FIG. 5 is a schematic cross-sectional view for illustrating an optical member according to still another embodiment of the present invention.

FIG. 6 is a schematic cross-sectional view for illustrating an optical member according to still another embodiment of the present invention.

FIG. 7 is a schematic perspective view of an example of a reflective polarizer that may be used for the optical member of the present invention.

FIG. 8 is a graph for showing the spectrum of light extracted from an optical member of Example 1.

FIG. 9 is a graph for showing the spectrum of light extracted from an optical member of Comparative Example 1.

FIG. 10 is a chromaticity diagram into which each of the spectra of light extracted from the optical members of Example 1 and Comparative Example 1 has been fitted.

### DESCRIPTION OF EMBODIMENTS

A. Entire Configuration of Optical Member

First, the entire configuration of an optical member according to a typical embodiment of the present invention is described with reference to the drawings. In the respective drawings, like constituent elements are denoted by like reference numerals, and overlapping description is omitted. In addition, for ease of viewing, a ratio among the thicknesses of layers in the drawings is different from an actual one. Constituent elements of the optical member are described in detail in the section B to the section G.

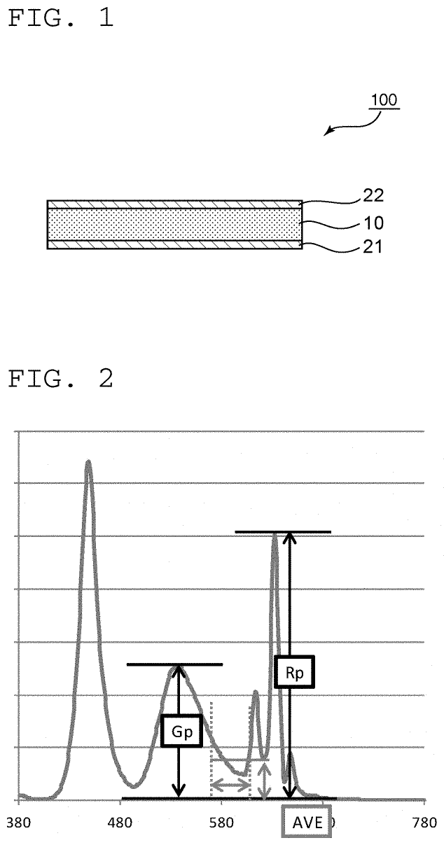

FIG. 1 is a schematic cross-sectional view for illustrating an optical member according to one embodiment of the present invention. An optical member 100 includes, in the stated order, a first barrier layer 21, a wavelength conversion layer 10, and a second barrier layer 22. The emission spectrum of light to be extracted from the optical member of the present invention has, as shown in FIG. 2, a peak having an intensity Gp (sometimes referred to as peak Gp) in a wavelength band of from 515 nm to 550 nm, and a peak having an intensity Rp (sometimes referred to as peak Rp) in a wavelength band of from 605 nm to 650 nm, and an average value Ave of intensities in a wavelength band of from 570 nm to 600 nm in the emission spectrum and an average value of Gp and Rp satisfy the following expression (1):

Ave≤0.1×{(Gp+Rp)/2} (1).

The expression (1) means that, with respect to the peak intensity Gp of green light and the peak intensity Rp of red light, a trough therebetween is deep, and the green light and the red light are independent of each other without having a mixed color. As a result, when the optical member of the present invention is applied to a liquid crystal display apparatus, an extremely excellent color rendering property can be achieved.

The wavelength conversion layer 10 may adopt any appropriate configuration that can satisfy the characteristics as described above. The wavelength conversion layer 10 typically includes a matrix and a wavelength conversion material dispersed in the matrix. In one embodiment, the matrix is a resin film. In another embodiment, the matrix is a pressure-sensitive adhesive. When the matrix is the pressure-sensitive adhesive, any one of the first barrier layer 21 or the second barrier layer 22 may be omitted. Accordingly, another optical member or an optical film can be bonded to the optical member of the present invention through intermediation of the wavelength conversion layer, and as a result, a contribution can be made to the thinning of the optical member (ultimately of a liquid crystal display apparatus).

The wavelength conversion layer 10 may contain only one kind of wavelength conversion material, or may contain two or more kinds (e.g., two kinds, three kinds, or four or more kinds) of wavelength conversion materials. In one embodiment, the wavelength conversion layer may contain two kinds of wavelength conversion materials (a first wavelength conversion material and a second wavelength conversion material). In this case, the first wavelength conversion material preferably has a center emission wavelength in a wavelength band ranging from 515 nm to 550 nm, and the second wavelength conversion material preferably has a center emission wavelength in a wavelength band ranging from 605 nm to 650 nm. Therefore, the first wavelength conversion material can be excited by excitation light (in the present invention, light from a backlight light source) to emit green light, and the second wavelength conversion material can be excited by the excitation light to emit red light. An excellent hue can be achieved by forming a wavelength conversion layer configured to extract red light and green light having center emission wavelengths in such wavelength bands. Further, when such wavelength conversion layer is integrated with a polarizing plate, display unevenness can be further suppressed.

Any appropriate configuration may be adopted for the wavelength conversion material. For example, the wavelength conversion material may be quantum dots, or may be a phosphor. In one embodiment, the first wavelength conversion material and the second wavelength conversion material may each be quantum dots. In another embodiment, one of the first wavelength conversion material or the second wavelength conversion material may be quantum dots, the other being a phosphor. For example, the first wavelength conversion material may be quantum dots, the second wavelength conversion material being a phosphor. In still another embodiment, the first wavelength conversion material and the second wavelength conversion material may each be a phosphor. Through appropriate combination of the wavelength conversion materials (e.g., the first wavelength conversion material and the second wavelength conversion material), a wavelength conversion layer having such characteristics as to satisfy the expression (1) can be obtained. For example, when quantum dots are used as the first wavelength conversion material (green) and a phosphor is used as the second wavelength conversion material (red), the trough between the peak Gp and the peak Rp can be deepened in the emission spectrum of light to be extracted from the optical member. As a result, the average value Ave of the intensities in the wavelength band of from 570 nm to 590 nm can be reduced so as to satisfy the expression (1).

FIG. 3 is a schematic cross-sectional view for illustrating an optical member according to another embodiment of the present invention. An optical member 101 further includes a reflective polarizer 40 on the outer side of the first barrier layer 21 or the second barrier layer 22. When the optical member is used for a liquid crystal display apparatus, the reflective polarizer 40 may be typically arranged on a liquid crystal display apparatus side. In the illustrated example, the reflective polarizer 40 is arranged on the outer side of the second barrier layer 22.

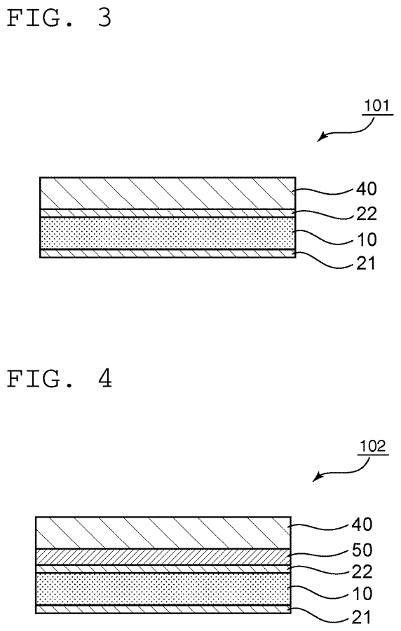

FIG. 4 is a schematic cross-sectional view for illustrating an optical member according to still another embodiment of the present invention. An optical member 102 further includes a low-refractive index layer 50 between the reflective polarizer 40 and the barrier layer (in the illustrated example, the second barrier layer 22). The low-refractive index layer 50 preferably has a refractive index of 1.30 or less.

FIG. 5 is a schematic cross-sectional view for illustrating an optical member according to still another embodiment of the present invention. An optical member 103 further includes at least one prism sheet between the reflective polarizer 40 and the barrier layer (in the illustrated example, the second barrier layer 22). In the illustrated example, two prism sheets (a first prism sheet 60 and a second prism sheet 70) are arranged. That is, the two prism sheets 60 and 70 are incorporated into the optical member 103 according to this embodiment, in which the first barrier layer 21 and the reflective polarizer 40, and the sheets and layers therebetween are integrated with each other. When the prism sheets are incorporated and integrated into the optical member as described above, an air layer between each of the prism sheets and a layer adjacent thereto can be eliminated, and hence a contribution can be made to the thinning of a liquid crystal display apparatus. The thinning of the liquid crystal display apparatus broadens the range of design choices, and hence has a high commercial value. Further, the integration of the prism sheets can prevent the prism sheets from being flawed due to friction during mounting of the prism sheets onto a surface light source device (a backlight unit, substantially a light guide plate), and hence can provide a liquid crystal display apparatus capable of preventing cloudiness of its display resulting from such flaw and excellent in mechanical strength. Further, by virtue of the incorporation of the wavelength conversion layer into such integrated optical member, when the optical member is applied to a liquid crystal display apparatus, display unevenness can be satisfactorily suppressed. The first prism sheet 60 typically includes a substrate portion 61 and a prism portion 62. The second prism sheet 70 typically includes a substrate portion 71 and a prism portion 72. The first prism sheet 60 and the second prism sheet 70 each have a flat first main surface on the wavelength conversion layer 10 side (flat surface of the substrate portion 61, 71), and a second main surface having an uneven shape on the opposite side to the wavelength conversion layer 10 (surface having convex portions formed by a plurality of columnar unit prisms 63, 73 arrayed on the opposite side to the wavelength conversion layer). In this embodiment, convex portions formed by the unit prisms 63 on the second main surface of the first prism sheet 60 are bonded to the first main surface of the second prism sheet 70 (flat surface of the substrate portion 71). As a result, a void portion is defined between each of concave portions on the second main surface of the first prism sheet 60 and the first main surface of the second prism sheet 70. With such configuration, when the optical member is applied to a liquid crystal display apparatus, an excellent hue and suppression of display unevenness can be simultaneously achieved. Herein, such adhesion of the prism sheets (substantially the unit prisms) only at the convex portions is sometimes referred to as “point adhesion” for convenience. The second prism sheet 70 is subjected to the point adhesion, for example, to the reflective polarizer 40.

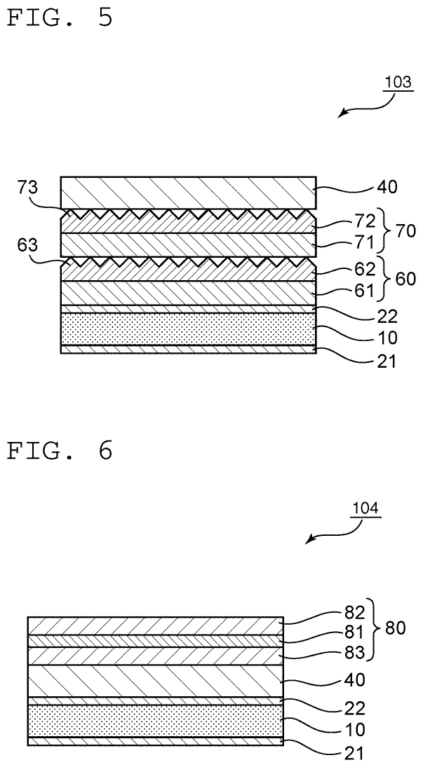

FIG. 6 is a schematic cross-sectional view for illustrating an optical member according to still another embodiment of the present invention. An optical member 104 further includes a polarizing plate 80 on the opposite side of the reflective polarizer 40 to the barrier layer (in the illustrated example, the second barrier layer 22). The polarizing plate 80 typically includes an absorption-type polarizer 81, a protective layer 82 arranged on one side of the absorption-type polarizer 81, and a protective layer 83 arranged on the other side of the absorption-type polarizer 81. Depending on purposes, one of the first protective layer 82 and the second protective layer 83 of the polarizing plate 80 may be omitted. For example, when the reflective polarizer 40 can function also as a protective layer for the absorption-type polarizer 81, the second protective layer 83 may be omitted.

In one embodiment, the optical member of the present invention may have an elongate shape. That is, the constituent elements of the optical member (e.g., the wavelength conversion layer, the pressure-sensitive adhesive layer, the barrier layer, the reflective polarizer, the low-refractive index layer, the first and second prism sheets, and the polarizing plate) may each have an elongate shape. The optical member having an elongate shape can be produced by a roll-to-roll process, and hence is excellent in production efficiency.

The constituent elements of the optical member may be laminated via any appropriate adhesion layer (e.g., an adhesive layer or a pressure-sensitive adhesive layer: not shown).

The above-mentioned embodiments may be appropriately combined, and modifications obvious in the art may be made to the constituent elements in the above-mentioned embodiments. For example, the low-refractive index layer 50 of FIG. 5 and the prism sheet 60 and/or the prism sheet 70 of FIG. 6 may be simultaneously arranged. In this case, the prism sheet(s) may be arranged between the low-refractive index layer 50 and the reflective polarizer 40. Further, in this case, another low-refractive index layer may be arranged between the prism sheet(s) and the reflective polarizer. In addition, for example, the reflective polarizer may be omitted in the embodiments of FIG. 3 to FIG. 6. In addition, for example, the second barrier layer 22 may be omitted in the embodiments of FIG. 3 to FIG. 6. Further, the constituent elements may each be replaced with an optically equivalent configuration.

B. Wavelength Conversion Layer

As described above, the wavelength conversion layer 10 typically includes a matrix and a wavelength conversion material dispersed in the matrix.

B-1. Matrix

It is preferred that a material for forming the matrix (hereinafter sometimes referred to as “matrix material”) have low oxygen permeability and low moisture permeability, have high light stability and high chemical stability, have a predetermined refractive index, have excellent transparency, and/or have excellent dispersibility of the wavelength conversion material. The matrix may be a resin film, or may be a pressure-sensitive adhesive.

B-1-1. Resin Film

When the matrix is the resin film, any appropriate resin may be used as a resin for forming the resin film. Specifically, the resin may be a thermoplastic resin, may be a thermosetting resin, or may be an active energy ray-curable resin. Examples of the active energy ray-curable resin include an electron beam-curable resin, a UV-curable resin, and a visible ray-curable resin. Specific examples of the resin include an epoxy, a (meth)acrylate (e.g., methyl methacrylate or butyl acrylate), norbornene, polyethylene, poly(vinyl butyral), poly(vinyl acetate), polyurea, polyurethane, amino silicone (AMS), polyphenylmethylsiloxane, polyphenylalkylsiloxane, polydiphenylsiloxane, polydialkylsiloxane, silsesquioxane, silicone fluoride, vinyl and hydrogenated product-substituted silicone, a styrene-based polymer (e.g., polystyrene, amino polystyrene (APS), or poly(acrylonitrile ethylene styrene) (AES)), a polymer cross-linked with a bifunctional monomer (e.g., divinylbenzene), a polyester-based polymer (e.g., polyethylene terephthalate), a cellulose-based polymer (e.g., triacetylcellulose), a vinyl chloride-based polymer, an amide-based polymer, an imide-based polymer, a vinyl alcohol-based polymer, an epoxy-based polymer, a silicone-based polymer, and an acrylic urethane-based polymer. Those resins may be used alone or in combination thereof (e.g., a blend or a copolymer). After any such resin has been formed into a film, the film may be subjected to treatment, such as stretching, heating, or pressurization. Of those, a thermosetting resin or a UV-curable resin is preferred, and a thermosetting resin is more preferred. This is because such resin can be suitably applied to a case in which the optical member of the present invention is produced by a roll-to-roll process.

B-1-2. Pressure-Sensitive Adhesive

When the matrix is the pressure-sensitive adhesive, any appropriate pressure-sensitive adhesive may be used as the pressure-sensitive adhesive. The pressure-sensitive adhesive preferably has transparency and optical isotropy. Specific examples of the pressure-sensitive adhesive include a rubber-based pressure-sensitive adhesive, an acrylic pressure-sensitive adhesive, a silicone-based pressure-sensitive adhesive, an epoxy-based pressure-sensitive adhesive, and a cellulose-based pressure-sensitive adhesive. Of those, a rubber-based pressure-sensitive adhesive or an acrylic pressure-sensitive adhesive is preferred.

A rubber-based polymer for the rubber-based pressure-sensitive adhesive (pressure-sensitive adhesive composition) is a polymer showing rubber elasticity in a temperature region around room temperature. A rubber-based polymer (A) is preferably, for example, a styrene-based thermoplastic elastomer (A1), an isobutylene-based polymer (A2), or a combination thereof.

Examples of the styrene-based thermoplastic elastomer (A1) include styrene-based block copolymers, such as a styrene-ethylene-butylene-styrene block copolymer (SEBS), a styrene-isoprene-styrene block copolymer (SIS), a styrene-butadiene-styrene block copolymer (SBS), a styrene-ethylene-propylene-styrene block copolymer (SEPS, hydrogenated product of SIS), a styrene-ethylene-propylene block copolymer (SEP, hydrogenated product of a styrene-isoprene block copolymer), and a styrene-isobutylene-styrene block copolymer (SIBS), and a styrene-butadiene rubber (SBR). Of those, a styrene-ethylene-propylene-styrene block copolymer (SEPS, a hydrogenated product of SIS), a styrene-ethylene-butylene-styrene block copolymer (SEBS), or a styrene-isobutylene-styrene block copolymer (SIBS) is preferred from the viewpoint of having polystyrene blocks at both molecular ends so as to have a high cohesive strength as a polymer. A commercially available product may be used as the styrene-based thermoplastic elastomer (A1). Specific examples of the commercially available product include SEPTON and HYBRAR manufactured by Kuraray Co., Ltd., Tuftec manufactured by Asahi Kasei Chemicals Corporation, and SIBSTAR manufactured by Kaneka Corporation.

The weight-average molecular weight of the styrene-based thermoplastic elastomer (A1) is preferably from about 50,000 to about 500,000, more preferably from about 50,000 to about 300,000, still more preferably from about 50,000 to about 250,000. A case in which the weight-average molecular weight of the styrene-based thermoplastic elastomer (A1) falls within such range is preferred because the cohesive strength and viscoelasticity of the polymer can both be achieved.

The styrene content in the styrene-based thermoplastic elastomer (A1) is preferably from about 5 wt % to about 70 wt %, more preferably from about 5 wt % to about 40 wt %, still more preferably from about 10 wt % to about 20 wt %. A case in which the styrene content in the styrene-based thermoplastic elastomer (A1) falls within such range is preferred because the viscoelasticity exhibited by a soft segment can be secured while the cohesive strength exhibited by a styrene moiety is kept.

An example of the isobutylene-based polymer (A2) may be a polymer containing isobutylene as a constituent monomer and preferably having a weight-average molecular weight (Mw) of 500,000 or more. The isobutylene-based polymer (A2) may be a homopolymer of isobutylene (polyisobutylene, PIB), or may be a copolymer containing isobutylene as a main monomer (i.e., a copolymer having isobutylene copolymerized therein at a ratio of more than 50 mol %). Examples of such copolymer may include a copolymer of isobutylene and n-butylene, a copolymer of isobutylene and isoprene (e.g., a butyl rubber, such as a regular butyl rubber, a chlorinated butyl rubber, a brominated butyl rubber, or a partially cross-linked butyl rubber), and vulcanized products and modified products thereof (e.g., products each obtained by modification with a functional group, such as a hydroxyl group, a carboxyl group, an amino group, or an epoxy group). Of those, polyisobutylene (PIB) is preferred from the viewpoint of being free of a double bond in its main chain so as to be excellent in weatherability. A commercially available product may be used as the isobutylene-based polymer (A2). A specific example of the commercially available product is OPPANOL manufactured by BASF SE.

The weight-average molecular weight (Mw) of the isobutylene-based polymer (A2) is preferably 500,000 or more, more preferably 600,000 or more, still more preferably 700,000 or more. In addition, the upper limit of the weight-average molecular weight (Mw) is preferably 5,000,000 or less, more preferably 3,000,000 or less, still more preferably 2,000,000 or less. When the weight-average molecular weight of the isobutylene-based polymer (A2) is set to 500,000 or more, the pressure-sensitive adhesive composition can be made more excellent in durability under high-temperature storage.

The content of the rubber-based polymer (A) in the pressure-sensitive adhesive (pressure-sensitive adhesive composition) is preferably 30 wt % or more, more preferably 40 wt % or more, still more preferably 50 wt % or more, particularly preferably 60 wt % or more in the total solid content of the pressure-sensitive adhesive composition. The upper limit of the content of the rubber-based polymer is preferably 95 wt % or less, more preferably 90 wt % or less.

In the rubber-based pressure-sensitive adhesive, the rubber-based polymer (A) and other rubber-based polymer may be used in combination. Specific examples of the other rubber-based polymer include: a butyl rubber (IIR), a butadiene rubber (BR), an acrylonitrile-butadiene rubber (NBR), EPR (binary ethylene-propylene rubber), EPT (ternary ethylene-propylene rubber), an acrylic rubber, a urethane rubber, and a polyurethane-based thermoplastic elastomer; a polyester-based thermoplastic elastomer; and a blend-based thermoplastic elastomer, such as a polymer blend of polypropylene and EPT (ternary ethylene-propylene rubber). The blending amount of the other rubber-based polymer is preferably about 10 parts by weight or less with respect to 100 parts by weight of the rubber-based polymer (A).

An acrylic polymer for the acrylic pressure-sensitive adhesive (pressure-sensitive adhesive composition) typically contains an alkyl (meth)acrylate as a main component, and may contain, as a copolymerization component appropriate for a purpose, an aromatic ring-containing (meth)acrylate, an amide group-containing monomer, a carboxyl group-containing monomer, and/or a hydroxyl group-containing monomer. The term “(meth)acrylate” as used herein means acrylate and/or methacrylate. Examples of the alkyl (meth)acrylate may include (meth)acrylates of linear or branched alkyl groups each having 1 to 18 carbon atoms. The aromatic ring-containing (meth)acrylate is a compound containing an aromatic ring structure in its structure, and containing a (meth)acryloyl group therein. Examples of the aromatic ring include a benzene ring, a naphthalene ring, and a biphenyl ring. The aromatic ring-containing (meth)acrylate can satisfy durability (in particular, durability with respect to a transparent conductive layer) and alleviate display unevenness caused by a white void in a peripheral portion. The amide group-containing monomer is a compound containing an amide group in its structure, and containing a polymerizable unsaturated double bond, such as a (meth)acryloyl group or a vinyl group, therein. The carboxyl group-containing monomer is a compound containing a carboxyl group in its structure, and containing a polymerizable unsaturated double bond, such as a (meth)acryloyl group or a vinyl group, therein. The hydroxyl group-containing monomer is a compound containing a hydroxyl group in its structure, and containing a polymerizable unsaturated double bond, such as a (meth)acryloyl group or a vinyl group, therein. The details of the acrylic pressure-sensitive adhesive are described in, for example, JP 2015-199942 A, the description of which is incorporated herein by reference.

B-2. Wavelength Conversion Material

The wavelength conversion material can control the wavelength conversion characteristic of the wavelength conversion layer. As described above, the wavelength conversion material may be, for example, quantum dots or a phosphor.

The content of the wavelength conversion material (when two or more kinds are used, the total content thereof) in the wavelength conversion layer is preferably from 0.01 part by weight to 50 parts by weight, more preferably from 0.01 part by weight to 35 parts by weight, still more preferably from 0.01 part by weight to 30 parts by weight with respect to 100 parts by weight of the matrix material (typically the solid content of the resin or the pressure-sensitive adhesive). When the content of the wavelength conversion material falls within such range, a liquid crystal display apparatus excellent in balance among all the RGB hues can be achieved.

B-2-1. Quantum Dots

The quantum dots may be used alone or in combination of two or more kinds (e.g., two kinds, three kinds, or four or more kinds) thereof. For example, when quantum dots having different center emission wavelengths are used in appropriate combination, a wavelength conversion layer that achieves light having a desired center emission wavelength can be formed. The center emission wavelength of each of the quantum dots may be adjusted on the basis of, for example, the material and/or composition, particle size, and shape of each of the quantum dots. In one embodiment, two kinds of quantum dots (first quantum dots and second quantum dots) may be used. When those quantum dots are appropriately combined, light having a center emission wavelength in a desired wavelength band can be achieved by allowing light having a predetermined wavelength (light from a backlight light source) to enter and pass through the wavelength conversion layer. For example, the first quantum dots preferably each have a center emission wavelength in a wavelength band ranging from 515 nm to 550 nm, and the second quantum dots preferably each have a center emission wavelength in a wavelength band ranging from 605 nm to 650 nm. Therefore, the first quantum dots can each be excited by excitation light (in the present invention, light from a backlight light source) to emit green light, and the second quantum dots can each be excited by the excitation light to emit red light. With such configuration, when the optical member is applied to a liquid crystal display apparatus, it is possible to suppress display unevenness and achieve an excellent hue by further combining quantum dots each capable of emitting blue light as required.

The quantum dots may each be formed of any appropriate material. The quantum dots may each be formed of preferably an inorganic material, more preferably an inorganic conductor material or an inorganic semiconductor material. Examples of the semiconductor material include semiconductors of Groups II-VI, Groups III-V, Groups IV-VI, and Group IV. Specific examples thereof include Si, Ge, Sn, Se, Te, B, C (including diamond), P, BN, BP, BAs, AlN, Alp, AlAs, AlSb, GaN, GaP, GaAs, GaSb, InN, InP, InAs, InSb, ZnO, ZnS, ZnSe, ZnTe, CdS, CdSe, CdSeZn, CdTe, HgS, HgSe, HgTe, BeS, BeSe, BeTe, MgS, MgSe, GeS, GeSe, GeTe, SnS, SnSe, SnTe, PbO, PbS, PbSe, PbTe, CuF, CuCl, CuBr, CuI, Si₃N₄, Ge₃N₄, Al₂O₃, (Al, Ga, In)₂(S, Se, Te)₃, and Al₂CO. Those semiconductor materials may be used alone or in combination thereof. The quantum dots may each contain a p-type dopant or an n-type dopant. In addition, the quantum dots may each have a core-shell structure. In the core-shell structure, any appropriate functional layer (a single layer or a plurality of layers) may be formed on the periphery of a shell depending on purposes, or the surface of the shell may be subjected to surface treatment and/or chemical modification.

Any appropriate shape may be adopted as the shape of each of the quantum dots depending on purposes. Specific examples thereof include a true spherical shape, a flaky shape, a plate-like shape, an ellipsoidal shape, and an amorphous shape.

Any appropriate size may be adopted as the size of each of the quantum dots depending on a desired emission wavelength. The size of each of the quantum dots is typically from 1 nm to 20 nm, preferably from 1 nm to 10 nm, more preferably from 2 nm to 8 nm. When the size of each of the quantum dots falls within such range, sharp emission is shown for each of green light and red light, and a high color rendering property can be achieved. For example, green light can be emitted when the quantum dots each have a size of about 7 nm, and red light can be emitted when the quantum dots each have a size of about 3 nm. When the quantum dots each have, for example, a true spherical shape, the size of each of the quantum dots is the average particle diameter, and when the quantum dots each have any other shape, the size is a dimension along the shortest axis in the shape.

The details of the quantum dots are described in, for example, JP 2012-169271 A, JP 2015-102857 A, JP 2015-65158 A, JP 2013-544018 A, and JP 2010-533976 A, the descriptions of which are incorporated herein by reference. Commercially available products may be used as the quantum dots.

B-2-2. Phosphor

Any appropriate phosphor capable of emitting light of a desired color depending on purposes may be used as the phosphor. Specific examples thereof include a red phosphor and a green phosphor.

An example of the red phosphor is a complex fluoride phosphor activated with Mn⁴⁺. The complex fluoride phosphor refers to a coordination compound containing at least one coordination center (e.g., M to be described later) surrounded by fluoride ions acting as ligands, in which, as required, electric charge is compensated for by a counterion (e.g., A to be described later). Specific examples thereof include A₂[MF₅]:Mn⁴⁺, A₃[MF₆]:Mn⁴⁺, Zn₂[MF₇]:Mn⁴⁺, A[In₂F₇]:Mn⁴⁺, A₂[M′F₆]:Mn⁴⁺, E [M′F₆]:Mn⁴⁺, A₃[ZrF₇]:Mn⁴⁺, and Ba_{0.65}Zr_{0.35}F_{2.70}:Mn⁴⁺. In the formulae, A represents Li, Na, K, Rb, Cs, or NH₄, or a combination thereof. M represents Al, Ga, or In, or a combination thereof. M′ represents Ge, Si, Sn, Ti, or Zr, or a combination thereof. E represents Mg, Ca, Sr, Ba, or Zn, or a combination thereof. Of those, a complex fluoride phosphor having a coordination number at the coordination center of 6 is preferred. The details of such red phosphor are described in, for example, JP 2015-84327 A, the description of which is incorporated herein by reference in its entirety.

An example of the green phosphor is a compound containing, as a main component, a solid solution of SiAlON having a β-Si₃N₄ crystal structure. Treatment for adjusting the amount of oxygen contained in such SiAlON crystal to a specific amount (e.g., 0.8 mass %) or less is preferably performed. When such treatment is performed, a green phosphor capable of emitting sharp light with a small peak width can be obtained. The details of such green phosphor are described in, for example, JP 2013-28814 A, the description of which is incorporated herein by reference in its entirety.

In one embodiment, quantum dots each capable of emitting green light may be used in combination with a red phosphor. An example of the quantum dots each capable of emitting green light is quantum dots each of which has an InP core, has a particle diameter of 10 nm or less, and has its center emission wavelength adjusted to 530 nm. An example of the red phosphor is the complex fluoride phosphor activated with Mn⁴⁺. Such quantum dots each have a small half width of the center emission wavelength (peak), and such red phosphor does not have an absorption edge base overlapping a green region. Accordingly, a mixed color between red and green can be satisfactorily prevented. In this embodiment, with regard to a blending ratio between the quantum dots and the phosphor, the phosphor may be blended at preferably from 10 parts by weight to 10,000 parts by weight, more preferably from 50 parts by weight to 5,000 parts by weight with respect to 100 parts by weight of the quantum dots.

B-3. Barrier Function

Irrespective of whether the matrix is the resin film or the pressure-sensitive adhesive, the wavelength conversion layer preferably has a barrier function against oxygen and/or water vapor. The phrase “has a barrier function” as used herein means controlling the transmission amount of oxygen and/or water vapor penetrating into the wavelength conversion layer to substantially shield the quantum dots therefrom. The wavelength conversion layer may express the barrier function by imparting, to the quantum dots themselves, a three-dimensional structure, such as a core-shell structure or a tetrapod-like structure. In addition, the wavelength conversion layer may express the barrier function through appropriate selection of the matrix material. The wavelength conversion layer may preferably express the barrier function by blending a layered silicate subjected to organizing treatment (organized layered silicate). In addition, the barrier function of the wavelength conversion layer can be further promoted by the barrier layer to be described later.

The organized layered silicate may be obtained by appropriately subjecting a layered silicate to organizing treatment. The layered silicate has, for example, a laminated structure in which several hundred to several thousand plate crystals (each having, for example, a thickness of 1 nm), each of which is formed of two silica tetrahedral layers, and a magnesium octahedral layer or aluminum octahedral layer present between the two silica tetrahedral layers, are laminated. Examples of the layered silicate include smectite, bentonite, montmorillonite, and kaolinite.

The thickness of the layered silicate is preferably from 0.5 nm to 30 nm, more preferably from 0.8 nm to 10 nm. The length of the long side of the layered silicate is preferably from 50 nm to 1,000 nm, more preferably from 300 nm to 600 nm. The long side of the layered silicate means the longest side out of sides forming the layered silicate.

The aspect ratio of the layered silicate (ratio L/T of its thickness T and the length L of its long side) is preferably 25 or more, more preferably 200 or more. When a layered silicate having a high aspect ratio is used, a wavelength conversion layer having high gas barrier properties can be obtained even if the addition amount of the layered silicate is small. In addition, when the addition amount of the layered silicate is small, a wavelength conversion layer having high transparency and excellent in flexibility can be obtained. The upper limit of the aspect ratio of the layered silicate is generally 300.

The organized layered silicate is free of coloring even under a temperature of preferably 200° C. or more, more preferably 230° C. or more, still more preferably from 230° C. to 400° C. The organized layered silicate is preferably free of coloring even when heated at 230° C. for 10 minutes. The phrase “free of coloring” as used herein means that the organized layered silicate is free of coloring when visually observed.

The organizing treatment is performed by cation exchange of an inorganic cation (e.g., Na⁺, Ca²⁺, Al³⁺, or Mg²⁺) originally present between the plate crystals in the layered silicate through the use of an appropriate salt serving as an organizing treatment agent. Examples of the organizing treatment agent to be used for the cation exchange include nitrogen-containing heterocyclic quaternary ammonium salts and quaternary phosphonium salts. Of those, a quaternary imidazolium salt, a triphenylphosphonium salt, or the like is preferably used. A layered silicate subjected to the organizing treatment with any of those salts is excellent in heat resistance, and is free of coloring even under high temperature (e.g., 200° C. or more). In addition, the organized layered silicate is excellent in dispersibility in the wavelength conversion layer. The use of an organized layered silicate having high dispersibility allows the formation of a wavelength conversion layer having high transparency, high gas barrier properties, and high toughness. The quaternary imidazolium salt is more preferably used as the organizing treatment agent. The quaternary imidazolium salt is more excellent in heat resistance, and hence a wavelength conversion layer having less coloring even under high temperature can be obtained by using a layered silicate subjected to the organizing treatment with the quaternary imidazolium salt.

The counteranion of the salt to be used as the organizing treatment agent is, for example, Cl⁻, B⁻, or Br⁻. The counteranion is preferably Cl⁻ or B⁻, more preferably Cl⁻. A salt containing such counterion is excellent in exchangeability with the inorganic cation originally present in the layered silicate.

The salt to be used as the organizing treatment agent preferably has a long-chain alkyl group. The alkyl group has preferably 4 or more, more preferably 6 or more, still more preferably 8 to 12 carbon atoms. When a salt having the long-chain alkyl group is used, the salt widens a distance between the plate crystals in the layered silicate to weaken an interaction between the crystals, with the result that the dispersibility of the organized layered silicate is enhanced. When the dispersibility of the organized layered silicate is high, a wavelength conversion layer having high transparency and high gas barrier properties can be formed.

The thickness of the organized layered silicate is preferably from 0.5 nm to 30 nm, more preferably from 0.8 nm to 20 nm, still more preferably from 1 nm to 5 nm.

The organized layered silicate may be obtained by, for example, dispersing the layered silicate and the salt serving as the organizing treatment agent in any appropriate solvent (e.g., water), and stirring the dispersion under predetermined conditions. The addition amount of the salt serving as the organizing treatment agent is preferably 1.1 or more, more preferably 1.2 or more, still more preferably 1.5 or more times as large as the amount of the cation originally present in the layered silicate on a molar basis. Whether or not the layered silicate has been subjected to the organizing treatment may be confirmed on the basis of an increase in interlayer distance by measuring the interlayer distance of the layered silicate through X-ray diffraction analysis.

The blending amount of the organized layered silicate is preferably from 1 part by weight to 30 parts by weight, more preferably from 3 parts by weight to 20 parts by weight, still more preferably from 3 parts by weight to 15 parts by weight, particularly preferably from 5 parts by weight to 15 parts by weight with respect to 100 parts by weight of the matrix material (typically the solid content of a resin or a pressure-sensitive adhesive). When the blending amount falls within such range, a wavelength conversion layer excellent in gas barrier properties and transparency, and having little coloring can be obtained.

The water vapor transmission rate (moisture vapor transmission rate) of the wavelength conversion layer in terms of a thickness of 50 μm is preferably 100 g/(m²·day) or less, more preferably 80 g/(m²·day) or less.

B-4. Others

The wavelength conversion layer may further contain any appropriate additive depending on purposes. Examples of the additive include a light diffusing material, a material for imparting anisotropy to light, and a material for polarizing light. Specific examples of the light diffusing material include fine particles each formed of an acrylic resin, a silicone-based resin, a styrene-based resin, or a resin based on a copolymer thereof. Specific examples of the material for imparting anisotropy to light and/or the material for polarizing light include: ellipsoidal fine particles in each of which birefringence on its major axis differs from that on its minor axis; core-shell type fine particles; and laminated fine particles. The kind, number, blending amount, and the like of the additives may be appropriately set depending on purposes.

The wavelength conversion layer may be formed by, for example, applying a liquid composition containing the matrix material and the wavelength conversion material, and as required, the additive. For example, when the matrix material is a resin, the wavelength conversion layer may be formed by applying a liquid composition containing the matrix material and the wavelength conversion material, and as required, the additive, a solvent, and a polymerization initiator to any appropriate support, and then drying and/or curing the liquid composition. The solvent and the polymerization initiator may be appropriately set depending on the kind of the matrix material (resin) to be used. Any appropriate application method may be used as an application method. Specific examples thereof include a curtain coating method, a dip coating method, a spin coating method, a print coating method, a spray coating method, a slot coating method, a roll coating method, a slide coating method, a blade coating method, a gravure coating method, and a wire bar method. Curing conditions may be appropriately set depending on, for example, the kind of the matrix material (resin) to be used and the composition of the composition. When the quantum dots are added to the matrix material, the quantum dots may be added in a state of particles, or may be added in a state of a dispersion liquid by being dispersed in a solvent. The wavelength conversion layer may be formed on the barrier layer.

The wavelength conversion layer formed on the support may be transferred onto another constituent element of the optical member (e.g., the barrier layer, the low-refractive index layer, one of the prism sheets, or the reflective polarizer).

The wavelength conversion layer may be a single layer, or may have a laminated structure. When the wavelength conversion layer has a laminated structure, its layers may typically contain wavelength conversion materials having light emission characteristics different from each other.

The thickness of the wavelength conversion layer (when the wavelength conversion layer has a laminated structure, the total thickness thereof) is preferably from 20 μm to 500 μm, more preferably from 100 μm to 400 μm. When the thickness of the wave length conversion layer falls within such range, the wavelength conversion layer can be excellent in conversion efficiency and durability. Further, when the thickness is 20 μm or more, excellent barrier properties can be achieved. When the wavelength conversion layer has a laminated structure, the thickness of each of its layers is preferably from 10 μm to 300 μm, more preferably from 20 μm to 250 μm.

C. Barrier Layer

The barrier layer preferably has a barrier function against oxygen and/or water vapor. When the barrier layer is arranged, deterioration of the wavelength conversion material due to oxygen and/or water vapor can be prevented. As a result, a longer life of the function of the wavelength conversion layer can be achieved. The oxygen transmission rate of the barrier layer is preferably 10 cm³/(m²·day·atm) or less, more preferably 1 cm³/(m²·day·atm) or less, still more preferably 0.1 cm³/(m²·day·atm) or less. The oxygen transmission rate may be measured under an atmosphere at 25° C. and 0% RH by a measurement method in conformity to JIS K7126. The water vapor transmission rate (moisture vapor transmission rate) of the barrier layer is preferably 1 g/(m²·day) or less, more preferably 0.1 g/(m²·day) or less, still more preferably 0.01 g/(m²·day) or less. The water vapor transmission rate may be measured under an atmosphere at 40° C. and 90% RH by a measurement method in conformity to JIS K7129.

The barrier layer is typically a laminated film obtained by laminating, for example, a metal-deposited film, an oxide film, oxynitride film, or nitride film of a metal or silicon, or a metal foil on a resin film. The resin film may be omitted depending on the configuration of the optical member. The resin film may preferably have a barrier function, transparency, and/or optical isotropy. Specific examples of such resin include a cyclic olefin-based resin, a polycarbonate-based resin, a cellulose-based resin, a polyester-based resin, and an acrylic resin. Of those, a cyclic olefin-based resin (e.g., a norbornene-based resin), a polyester-based resin (e.g., polyethylene terephthalate (PET)), and an acrylic resin (e.g., an acrylic resin having a cyclic structure, such as a lactone ring or a glutarimide ring, in a main chain thereof) are preferred. Those resins can be excellent in balance among the barrier function, transparency, and optical isotropy.

A metal of the metal-deposited film is, for example, In, Sn, Pb, Cu, Ag, or Ti. A metal oxide is, for example, ITO, IZO, AZO, SiO₂, MgO, SiO, SiₓO_{y}, Al₂O₃, GeO, or TiO₂. The metal foil is, for example, an aluminum foil, a copper foil, or a stainless-steel foil.

An active barrier film may be used as the barrier layer. The active barrier film is a film capable of reacting with oxygen and actively absorbing oxygen. The active barrier film is commercially available. Specific examples of the commercially available product include “Oxyguard” manufactured by Toyobo Co., Ltd., “AGELESS OMAC” manufactured by Mitsubishi Gas Chemical Company, Inc., “OxyCatch” manufactured by Kyodo Printing Co., Ltd., and “EVAL AP” manufactured by Kuraray Co., Ltd.

The thickness of the barrier layer is, for example, from 50 nm to 50 μm.

D. Reflective Polarizer

The reflective polarizer 40 has a function of transmitting polarized light in a specific polarization state (polarization direction) and reflecting light in any other polarization state. The reflective polarizer 40 may be of a linearly polarized light separation type, or may be of a circularly polarized light separation type. Description is given below by taking the linearly polarized light separation-type reflective polarizer as an example. An example of the circularly polarized light separation-type reflective polarizer is a laminate of a film obtained by fixing a cholesteric liquid crystal and a λ/4 plate.

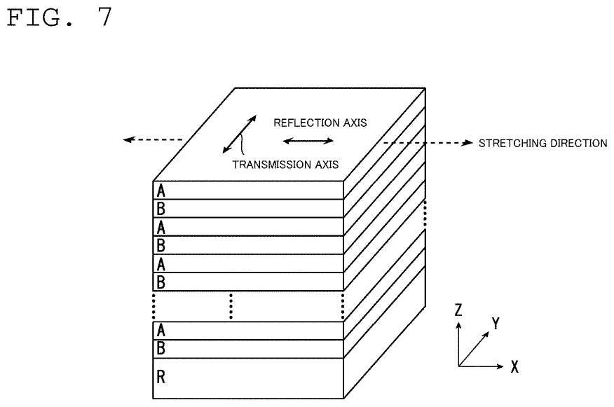

FIG. 7 is a schematic perspective view of an example of the reflective polarizer. The reflective polarizer is a multilayer laminate obtained by alternately laminating a layer A having birefringence and a layer B substantially free of birefringence. For example, the total number of the layers of such multilayer laminate may be from 50 to 1,000. In the illustrated example, a refractive index nx in the x-axis direction of the layer A is larger than a refractive index ny in the y-axis direction thereof, and a refractive index nx in the x-axis direction of the layer B and a refractive index ny in the y-axis direction thereof are substantially equal to each other. Therefore, a refractive index difference between the layer A and the layer B is large in the x-axis direction, and is substantially zero in the y-axis direction. As a result, the x-axis direction serves as a reflection axis and the y-axis direction serves as a transmission axis. The refractive index difference between the layer A and the layer B in the x-axis direction is preferably from 0.2 to 0.3. The x-axis direction corresponds to the stretching direction of the reflective polarizer in a method of producing the reflective polarizer.

The layer A is preferably formed of a material that expresses birefringence when stretched. Typical examples of such material include naphthalenedicarboxylic acid polyester (e.g., polyethylene naphthalate), polycarbonate, and an acrylic resin (e.g., polymethyl methacrylate). Of those, polyethylene naphthalate is preferred. The layer B is preferably formed of a material that is substantially free of expressing birefringence even when stretched. A typical example of such material is a copolyester of naphthalenedicarboxylic acid and terephthalic acid.

The reflective polarizer transmits light having a first polarization direction (e.g., a p-wave) and reflects light having a second polarization direction perpendicular to the first polarization direction (e.g., a s-wave) at an interface between the layer A and the layer B. Part of the reflected light passes as light having the first polarization direction through the interface between the layer A and the layer B, and the other part thereof is reflected as light having the second polarization direction. Such reflection and transmission are repeated many times in the reflective polarizer, and hence the utilization efficiency of light can be improved.

In one embodiment, the reflective polarizer may include, as illustrated in FIG. 7, a reflective layer R as the outermost layer on the wavelength conversion layer 10 side. When the reflective layer R is arranged, light that has finally returned to the outermost portion of the reflective polarizer without being utilized can be further utilized, and hence the utilization efficiency of the light can be further improved. The reflective layer R typically expresses a reflecting function by virtue of the multilayer structure of a polyester resin layer.

The total thickness of the reflective polarizer may be appropriately set depending on, for example, purposes and the total number of layers in the reflective polarizer. The total thickness of the reflective polarizer is preferably from 10 μm to 150 μm.

In one embodiment, in the optical member 105, the reflective polarizer 40 is arranged so as to transmit light having a polarization direction parallel to the transmission axis of the polarizing plate 80. That is, the reflective polarizer 40 is arranged so that its transmission axis is in a direction approximately parallel to the transmission axis direction of the polarizing plate 80. With such configuration, light to be absorbed by the polarizing plate 80 can be reutilized to enable a further improvement in utilization efficiency, and besides, the brightness can be enhanced.

The reflective polarizer may be typically produced by combining co-extrusion and lateral stretching. The co-extrusion may be performed by any appropriate system. For example, the system may be a feed block system, or may be a multi-manifold system. For example, a material for forming the layer A and a material for forming the layer B are extruded in a feed block, and are then formed into a plurality of layers with a multiplier. Such apparatus for forming the materials into a plurality of layers is known to one skilled in the art. Next, the resultant multilayer laminate having an elongate shape is typically stretched in a direction (TD) perpendicular to its conveying direction. The material for forming the layer A (e.g., polyethylene naphthalate) is increased in refractive index only in the stretching direction by the lateral stretching, and as a result, expresses birefringence. The material for forming the layer B (e.g., copolyester of naphthalenedicarboxylic acid and terephthalic acid) is not increased in refractive index in any direction even by the lateral stretching. As a result, a reflective polarizer having a reflection axis in the stretching direction (TD) and having a transmission axis in the conveying direction (MD) can be obtained (TD corresponds to the x-axis direction of FIG. 7, and MD corresponds to the y-axis direction thereof). A stretching operation may be performed with any appropriate apparatus.

A polarizer described in, for example, JP 09-507308 A may be used as the reflective polarizer.

A commercially available product may be used as it is as the reflective polarizer, or the commercially available product may be subjected to secondary processing (e.g., stretching) before use. Examples of the commercially available product include a product available under the product name “DBEF” from 3M Company and a product available under the product name “APF” from 3M Company.

E. Low-Refractive Index Layer

As described above, the refractive index of the low-refractive index layer 50 is preferably 1.30 or less. The refractive index of the low-refractive index layer 50 is preferably as close to the refractive index (1.00) of air as possible. Specifically, the refractive index of the low-refractive index layer is preferably 1.20 or less, more preferably 1.15 or less. The lower limit of the refractive index of the low-refractive index layer is, for example, 1.01. When the refractive index of the low-refractive index layer falls within such range, a liquid crystal display apparatus having high brightness while achieving remarkable thinning through the elimination of an air layer can be achieved.

The low-refractive index layer typically has a void in itself. The void ratio of the low-refractive index layer may take any appropriate value. The void ratio is, for example, from 5% to 99%, preferably from 25% to 95%. When the void ratio falls within the range, refractive index of the low-refractive index layer can be sufficiently reduced, and a high mechanical strength can be obtained.

The low-refractive index layer having a void in itself may be formed of, for example, a structure having at least one shape selected from a particle shape, a fibrous shape, and a flat plate-like shape. Structural bodies (constituent units) forming the particle shape may be solid particles, or may be hollow particles, and specific examples thereof include silicone particles, silicone particles having fine pores, silica hollow nanoparticles, and silica hollow nanoballoons. The constituent unit of the fibrous shape is, for example, nanofiber having a nanosize diameter, and specific examples thereof include cellulose nanofiber and alumina nanofiber. An example of the constituent unit of the flat plate-like shape is nanoclay, and a specific example thereof is nanosized bentonite (e.g., KunipiaF[product name]). In addition, in the void structural body used in the present invention, the constituent units formed of a single or one kind, or a plurality of kinds, which form the fine void structure, contain, for example, portions that are chemically bonded to each other directly or indirectly, through a catalytic action. In the present invention, that the constituent units are“bonded to each other indirectly” means that the constituent units are bonded to each other via a binder component in a small amount that is a constituent unit amount or less. That the constituent units are “bonded to each other directly” means that the constituent units are directly bonded to each other without a binder component or the like being interposed.

Any appropriate material may be adopted as a material for forming the low-refractive index layer. For example, materials described in WO 2004/113966 A1, JP 2013-254183 A, and JP 2012-189802 A may each be adopted as the material. Specific examples thereof include: silica-based compounds; hydrolyzable silanes, and partial hydrolysates and dehydration condensates thereof; organic polymers; silicon compounds each containing a silanol group; active silica obtained by bringing a silicate into contact with an acid or an ion exchange resin; polymerizable monomers (e.g., a (meth)acrylic monomer and a styrene-based monomer); curable resins (e.g., a (meth)acrylic resin, a fluorine-containing resin, and a urethane resin); and combinations thereof.

Examples of the organic polymers include polyolefins (e.g., polyethylene and polypropylene), polyurethanes, fluorine-containing polymers (e.g., a fluorine-containing copolymer having, as structural components, a fluorine-containing monomer unit and a structural unit for imparting cross-linking reactivity), polyesters (e.g., a poly(meth)acrylic acid derivative (the term “(meth)acrylic acid” as used herein refers to acrylic acid and methacrylic acid, and the term “(meth)” is always used in such meaning)), polyethers, polyamides, polyimides, polyureas, and polycarbonates.

The material preferably contains: a silica-based compound; or a hydrolyzable silane, or a partial hydrolysate or a dehydration condensate thereof.

Examples of the silica-based compound include: SiO₂ (silicic anhydride); and a compound containing SiO₂, and at least one compound selected from the group consisting of Na₂O—B₂O₃ (borosilicic acid), Al₂O₃ (alumina), B₂O₃, TiO₂, ZrO₂, SnO₂, Ce₂O₃, P₂O₅, Sb₂O₃, MoO₃, ZnO₂, WO₃, TiO₂—Al₂O₃, TiO₂—ZrO₂, In₂O₃—SnO₂, and Sb₂O₃—SnO₂ (the symbol “-” means that a compound of interest is a complex oxide).

An example of the hydrolyzable silane is a hydrolyzable silane containing an alkyl group that may have a substituent (e.g., fluorine). The hydrolyzable silane, and the partial hydrolysate and dehydration condensate thereof are preferably an alkoxysilane and a silsesquioxane.

The alkoxysilane may be a monomer or an oligomer. The alkoxysilane monomer preferably has 3 or more alkoxyl groups. Examples of the alkoxysilane monomer include methyltrimethoxysilane, methyltriethoxysilane, phenyltriethoxysilane, tetramethoxysilane, tetraethoxysilane, tetrabutoxysilane, tetrapropoxysilane, diethoxydimethoxysilane, dimethyldimethoxysilane, and dimethyldiethoxysilane. The alkoxysilane oligomer is preferably a polycondensate obtained by hydrolyzing and polycondensing any of the above-mentioned monomers. The use of the alkoxysilane as the material provides a low-refractive index layer having excellent uniformity.

The silsesquioxane is a generic term for network polysiloxane represented by a general formula RSiO_{1.5}, where R represents an organic functional group. Examples of R include an alkyl group (which may be linear or branched, and has 1 to 6 carbon atoms), a phenyl group, and an alkoxy group (e.g., a methoxy group and an ethoxy group). Examples of the structure of the silsesquioxane include a ladder-type structure and a cage-type structure. The use of the silsesquioxane as the material provides a low-refractive index layer having excellent uniformity, excellent weatherability, excellent transparency, and an excellent hardness.

Any appropriate particles may be adopted as the particles. The particles are each typically formed of a silica-based compound.

The shapes of the silica particles may be confirmed by, for example, observation with a transmission electron microscope. The average particle diameter of the particles is, for example, from 5 nm to 200 nm, preferably from 10 nm to 200 nm. The presence of the above-mentioned configuration can provide a low-refractive index layer having a sufficiently low refractive index and can maintain the transparency of the low-refractive index layer. The term “average particle diameter” as used herein means a value determined, by using a specific surface area (m²/g) measured by a nitrogen adsorption method (BET method), from an equation “average particle diameter=(2,720/specific surface area)” (see JP 01-317115 A).

Examples of a method of obtaining the low-refractive index layer include methods described in JP 2010-189212 A, JP 2008-040171 A, JP 2006-011175 A, WO 2004/113966 A1, and references thereof. Specific examples thereof include: a method involving hydrolyzing and polycondensing at least one of a silica-based compound, or a hydrolyzable silane, or a partial hydrolysate or a dehydration condensate thereof; a method involving using porous particles and/or hollow fine particles; a method involving utilizing a spring-back phenomenon to produce an aerogel layer; and a method involving using a pulverized gel, which is obtained by pulverizing a gel obtained by a sol-gel method and chemically bonding fine porous particles in the pulverized liquid to each other with a catalyst or the like. However, the method of obtaining the low-refractive index layer is not limited to those production methods, and the layer may be produced by any production method.

The haze of the low-refractive index layer is, for example, from 0.1% to 30%, preferably from 0.2% to 10%.

With regard to the mechanical strength of the low-refractive index layer, for example, its scratch resistance against BEMCOT (trademark) is desirably from 60% to 100%.

An anchoring force between the low-refractive index layer and the wavelength conversion layer is not particularly limited, and is, for example, 0.01 N/25 mm or more, preferably 0.1 N/25 mm or more, more preferably 1 N/25 mm or more. In order to increase the mechanical strength or the anchoring force, the low-refractive index layer may be subjected to undercoating treatment, heating treatment, humidifying treatment, UV treatment, corona treatment, plasma treatment, or the like before or after the formation of a coating film, or in a step before or after bonding to any appropriate adhesion layer or another member.

The thickness of the low-refractive index layer 50 is preferably from 100 nm to 5,000 nm, more preferably from 200 nm to 4,000 nm, still more preferably from 300 nm to 3,000 nm, particularly preferably from 500 nm to 2,000 nm. When the thickness of the low-refractive index layer falls within such range, a low-refractive index layer expressing an optically sufficient function for light in a visible light region and having excellent durability can be achieved.

F. Prism Sheet

### F-1. First Prism Sheet

As described above, the first prism sheet 60 typically includes the substrate portion 61 and the prism portion 62. When the optical member of the present invention is arranged on the backlight side of a liquid crystal display apparatus, the first prism sheet 60 guides polarized light, which has been output from the backlight unit, as polarized light having the maximum intensity in an approximately normal direction of the liquid crystal display apparatus to the polarizing plate by means of, for example, total reflection in the prism portion 62 while maintaining the polarization state of the light. The substrate portion 61 may be omitted depending on purposes and the configuration of the prism sheet. For example, when the low-refractive index layer 50 can function as a supporting member for the prism sheet, the substrate portion 61 may be omitted. The term “approximately normal direction” encompasses a direction within a predetermined angle with respect to a normal direction, for example, a direction within the range of ±10° with respect to the normal direction.

F-1-1. Prism Portion

In one embodiment, as described above, the first prism sheet 60 (substantially the prism portion 62) includes an array of the plurality of columnar unit prisms 63, which are convex toward the opposite side to the wavelength conversion layer 10. It is preferred that each of the unit prisms 63 be columnar, and its lengthwise direction (edge line direction) be directed toward a direction approximately perpendicular, or a direction approximately parallel, to the transmission axis of the polarizing plate. The expressions “substantially perpendicular” and “approximately perpendicular” as used herein encompass a case in which an angle formed by two directions is 90°±10°, and the angle is preferably 90°±7°, more preferably 90°±5°. The expressions “substantially parallel” and “approximately parallel” encompass a case in which an angle formed by two directions is 0°±10°, and the angle is preferably 0°±7°, more preferably 0°±5°. Further, the simple expression “perpendicular” or “parallel” as used herein may include a substantially perpendicular or substantially parallel state. The first prism sheet 60 may be arranged so that the edge line direction of each of the unit prisms 63 and the transmission axis of the polarizing plate form a predetermined angle (the so-called oblique arrangement). The adoption of such configuration can prevent the occurrence of moire in a more satisfactory manner in some cases. The range of the oblique arrangement is preferably 20° or less, more preferably 15° or less.

Any appropriate configuration may be adopted for the shape of each of unit prisms 63 as long as the effects of the present invention are obtained. The shape of a section of each of the unit prisms 63 parallel to its array direction and parallel to its thickness direction may be a triangular shape, or may be any other shape (e.g., such a shape that one or both of the inclined planes of a triangle has a plurality of flat surfaces having different tilt angles). The triangular shape may be a shape asymmetric with respect to a straight line passing the apex of the unit prism and perpendicular to the surface of the sheet (e.g., a scalene triangle), or may be a shape symmetric with respect to the straight line (e.g., an isosceles triangle). Further, the apex of the unit prism may have a chamfered curved surface shape, or may have a shape whose section is a trapezoid, the shape being obtained by such cutting that its tip becomes a flat surface. Detailed shapes of the unit prisms 63 may be appropriately set depending on purposes. For example, a configuration described in JP 11-84111 A may be adopted for each of the unit prisms 63.

All the unit prisms 63 may have the same height, or the unit prisms may have different heights. When the unit prisms have different heights, in one embodiment, the unit prisms have two heights. With such configuration, only unit prisms each having the larger height can be subjected to the point adhesion, and hence the point adhesion can be achieved to a desired degree by adjusting the positions and number of the unit prisms each having the larger height. For example, a unit prism having the larger height and a unit prism having the smaller height may be alternately arranged, a unit prism having the larger (or smaller) height may be arranged for, for example, every three, four, or five unit prisms, the unit prisms may be irregularly arranged depending on purposes, or the unit prisms may be completely randomly arranged. In another embodiment, the unit prisms have three or more heights. With such configuration, the degree to which the unit prisms to be subjected to the point adhesion are buried in the adhesive can be adjusted, and as a result, the point adhesion can be achieved to a more precise degree.

F-1-2. Substrate Portion

When the substrate portion 61 is arranged in the first prism sheet 60, the substrate portion 61 and the prism portion 62 may be integrally formed by, for example, subjecting a single material to extrusion, or the prism portion may be shaped on a film for the substrate portion. The thickness of the substrate portion is preferably from 25 μm to 150 μm. With such thickness, the handling property and strength of the prism sheet can be excellent.

Any appropriate material may be adopted as a material for forming the substrate portion 61 depending on purposes and the configuration of the prism sheet. When the prism portion is shaped on the film for the substrate portion, a specific example of the film for the substrate portion is a film formed of cellulose triacetate (TAC), a (meth)acrylic resin, such as polymethyl methacrylate (PMMA), or a polycarbonate (PC) resin. The film is preferably an unstretched film.

When the substrate portion 61 and the prism portion 62 are integrally formed of a single material, the same material as a material for forming the prism portion when the prism portion is shaped on the film for the substrate portion may be used as the material. Examples of the material for forming the prism portion include epoxy acrylate-based and urethane acrylate-based reactive resins (e.g., an ionizing radiation-curable resin). When the prism sheet of an integral configuration is formed, a polyester resin, such as PC or PET, an acrylic resin, such as PMMA or MS, or an optically transparent thermoplastic resin, such as cyclic polyolefin, may be used.

The substrate portion 61 preferably substantially has optical isotropy. The phrase “substantially has optical isotropy” as used herein means that a retardation value is so small as to have substantially no influences on the optical characteristics of the liquid crystal display apparatus. For example, the in-plane retardation Re of the substrate portion is preferably 20 nm or less, more preferably 10 nm or less. The in-plane retardation Re is an in-plane retardation value measured with light having a wavelength of 590 nm at 23° C. The in-plane retardation Re is expressed by Re=(nx-ny)×d. In the equation, nx represents a refractive index in a direction in which a refractive index becomes maximum in the plane of the optical member (i.e., a slow axis direction), ny represents a refractive index in a direction perpendicular to the slow axis in the plane (i.e., a fast axis direction), and d represents the thickness (nm) of the optical member.

Further, the photoelastic coefficient of the substrate portion 61 is preferably from −10×10⁻¹² m²/N to 10×10⁻¹² m²/N, more preferably from −5×10⁻¹² m²/N to 5×10⁻¹² m²/N, still more preferably from −3×10⁻¹² m²/N to 3×10⁻¹² m²/N.

F-2. Second Prism Sheet

In one embodiment, as described above, the first prism sheet 60 and the second prism sheet 70 are bonded to each other by the point adhesion. With such configuration, when the optical member is applied to a liquid crystal display apparatus, a liquid crystal display apparatus excellent in mechanical strength, having high brightness, suppressed in display unevenness, and having an excellent hue can be achieved. The configuration, function, and the like of the second prism sheet are as described in the section F-1 regarding the first prism sheet.

The technical significance of adopting the point adhesion as described above is as described below. A wavelength conversion layer to be applied to a liquid crystal display apparatus converts a part of incident light having a blue to bluish purple color into green light and red light, and outputs another part thereof as it is as blue light, to thereby achieve white light by the combination of the red light, the green light, and the blue light. In addition, in many cases, the wavelength conversion layer to be applied to a liquid crystal display apparatus has a yellow to orange color in association with its constituent material and light absorption. A prism sheet is typically used for enhancing brightness and a hue by the compensation of color conversion efficiency, which is insufficient with the wavelength conversion layer alone, through the utilization of its retroreflection. In this connection, the prism sheet has a function of condensing spreading light in a front direction, and hence high conversion efficiency is not sufficiently achieved in an oblique direction. As a result, the color of the wavelength conversion layer stands out to make the hue in the oblique direction look from yellow to orange, leading to a reduction in display quality of the liquid crystal display apparatus in many cases. Through the adoption of the point adhesion, an air layer is eliminated at each of the portions subjected to the point adhesion and a light-condensing property is reduced, with the result that light is allowed to spread to the surroundings. That is, as compared to a configuration in which the prism sheet is merely placed (separately arranged), light is diffused to the surroundings, and as a result, the hue in each of the front and oblique directions (in particular, the oblique direction) can be improved. Through the adjustment of the degree of the point adhesion (e.g., the number of the portions subjected to the point adhesion, the positions thereof, and the thickness of an adhesive to be used for the point adhesion), desired balance between brightness and hue can be achieved in both the front and oblique directions. Besides, when void portions having a predetermined voidage are formed through the adjustment of the degree of the point adhesion, more excellent brightness and a more excellent hue can be achieved.

G. Polarizing Plate

As described above, the polarizing plate 80 typically includes the absorption-type polarizer 81, the protective layer 82 arranged on one side of the absorption-type polarizer 81, and the protective layer 83 arranged on the other side of the absorption-type polarizer 81.

G-1. Polarizer

Any appropriate polarizer may be adopted as the absorption-type polarizer 81. For example, a resin film for forming the polarizer may be a single-layer resin film, or may be a laminate of two or more layers.

Specific examples of the polarizer including a single-layer resin film include: a polarizer obtained by subjecting a hydrophilic polymer film, such as a polyvinyl alcohol (PVA)-based film, a partially formalized PVA-based film, or an ethylene-vinyl acetate copolymer-based partially saponified film, to dyeing treatment with a dichroic substance, such as iodine or a dichroic dye, and stretching treatment; and a polyene-based alignment film, such as a dehydration-treated product of PVA or a dehydrochlorination-treated product of polyvinyl chloride. A polarizer obtained by dyeing the PVA-based film with iodine and uniaxially stretching the resultant is preferably used because the polarizer is excellent in optical characteristics.

The dyeing with iodine is performed by, for example, immersing the PVA-based film in an aqueous solution of iodine. The stretching ratio of the uniaxial stretching is preferably from 3 times to 7 times. The stretching may be performed after the dyeing treatment, or may be performed while the dyeing is performed. In addition, the dyeing may be performed after the stretching has been performed. The PVA-based film is subjected to swelling treatment, cross-linking treatment, washing treatment, drying treatment, or the like as required. For example, when the PVA-based film is immersed in water to be washed with water before the dyeing, contamination or an antiblocking agent on the surface of the PVA-based film can be washed off. In addition, the PVA-based film is swollen and hence dyeing unevenness or the like can be prevented.

The polarizer obtained by using the laminate is specifically, for example, a polarizer obtained by using a laminate of a resin substrate and a PVA-based resin layer (PVA-based resin film) laminated on the resin substrate, or a laminate of a resin substrate and a PVA-based resin layer formed on the resin substrate through application. The polarizer obtained by using the laminate of the resin substrate and the PVA-based resin layer formed on the resin substrate through application may be produced by, for example, a method involving: applying a PVA-based resin solution to the resin substrate; drying the solution to form the PVA-based resin layer on the resin substrate, thereby providing the laminate of the resin substrate and the PVA-based resin layer; and stretching and dyeing the laminate to turn the PVA-based resin layer into the polarizer. In this embodiment, the stretching typically includes the stretching of the laminate under a state in which the laminate is immersed in an aqueous solution of boric acid. The stretching may further include the aerial stretching of the laminate at high temperature (e.g., 95° C. or more) before the stretching in the aqueous solution of boric acid as required. The resultant laminate of the resin substrate and the polarizer may be used as it is (i.e., the resin substrate may be used as a protective layer for the polarizer). Alternatively, a product obtained as described below may be used: the resin substrate is peeled from the laminate of the resin substrate and the polarizer, and any appropriate protective layer in accordance with purposes is laminated on the peeling surface. The details of such method of producing a polarizer are described in, for example, JP 2012-73580 A, the description of which is incorporated herein by reference in its entirety.

The thickness of the polarizer is preferably 15 μm or less, more preferably from 1 μm to 12 μm, still more preferably from 3 μm to 12 μm, particularly preferably from 3 μm to 8 μm. When the thickness of the polarizer falls within such range, curling at the time of heating can be satisfactorily suppressed, and besides, satisfactory external appearance durability at the time of heating is obtained.

The polarizer preferably shows absorption dichroism at any wavelength in the wavelength range of from 380 nm to 780 nm. The single layer transmittance of the polarizer is typically from 43.0% to 46.0%, preferably from 44.5% to 46.0%. The polarization degree of the polarizer is preferably 97.0% or more, more preferably 99.0% or more, still more preferably 99.9% or more.

The single layer transmittance and polarization degree described above may be measured with a spectrophotometer. A specific measurement method for the polarization degree described above may involve measuring the parallel transmittance (H₀) and perpendicular transmittance (H₉₀) of the polarizer, and determining the polarization degree through the following expression: polarization degree (%)={(H₀−H₉₀)/(H₀+H₉₀)}^{1/2}×100. The parallel transmittance (H₀) described above refers to a value of a transmittance of a parallel-type laminated polarizer manufactured by causing two identical polarizers to overlap with each other so that absorption axes thereof are parallel to each other. In addition, the perpendicular transmittance (H₉₀) described above refers to a value of a transmittance of a perpendicular-type laminated polarizer manufactured by causing two identical polarizers to overlap with each other so that absorption axes thereof are perpendicular to each other. Each of those transmittances is a Y value obtained through visibility correction with the two-degree field of view (C light source) of JIS Z 8701-1982.

G-2. Protective Layer

The protective layer is formed of any appropriate film that may be used as a protective film for the polarizing plate. Specific examples of a material serving as a main component of the film include transparent resins, such as a cellulose-based resin, such as triacetylcellulose (TAC), a polyester-based resin, a polyvinyl alcohol-based resin, a polycarbonate-based resin, a polyamide-based resin, a polyimide-based resin, a polyether sulfone-based resin, a polysulfone-based resin, a polystyrene-based resin, a polynorbornene-based resin, a polyolefin-based resin, a (meth)acrylic resin, and an acetate-based resin. Another example thereof is a thermosetting resin or a UV-curable resin, such as a (meth)acrylic resin, a urethane-based resin, a (meth)acrylic urethane-based resin, an epoxy-based resin, or a silicone-based resin. Still another example thereof is a glassy polymer, such as a siloxane-based polymer. Further, a polymer film described in JP 2001-343529 A (WO 01/37007 A1) may also be used. As a material for the film, for example, there may be used a resin composition containing: a thermoplastic resin having a substituted or unsubstituted imide group in a side chain; and a thermoplastic resin having a substituted or unsubstituted phenyl group and a nitrile group in side chains. An example thereof is a resin composition containing an alternate copolymer formed of isobutene and N-methylmaleimide, and an acrylonitrile-styrene copolymer. The polymer film may be an extruded product of the resin composition, for example. The protective layers 52 and 53 may be identical to or different from each other.

The thickness of each of the protective layers is preferably from 20 μm to 100 μm. Each of the protective layers may be laminated on the polarizer via an adhesion layer (specifically an adhesive layer or a pressure-sensitive adhesive layer), or may be laminated so as to be in close contact with the polarizer (without the adhesion layer being interposed). The adhesive layer is formed of any appropriate adhesive. The adhesive is, for example, a water-soluble adhesive using a polyvinyl alcohol-based resin as a main component. The water-soluble adhesive using the polyvinyl alcohol-based resin as a main component may preferably further contain a metal compound colloid. The metal compound colloid may be such that metal compound fine particles are dispersed in a dispersion medium, and the colloid may be a colloid that electrostatically stabilizes as a result of interactive repulsion between the charges of the same kind of the fine particles to permanently have stability. The average particle diameter of the fine particles forming the metal compound colloid may be any appropriate value as long as the average particle diameter does not adversely affect the optical characteristics of the polarizer, such as a polarization characteristic. The average particle diameter is preferably from 1 nm to 100 nm, more preferably from 1 nm to 50 nm. This is because the fine particles can be uniformly dispersed in the adhesive layer, its adhesion can be secured, and a knick can be suppressed. The term “knick” refers to a local uneven defect that occurs at an interface between the polarizer and each of the protective layers.

H. Backlight Unit

The optical member of the present invention described in the sections A to G may be incorporated into a backlight unit. Therefore, the present invention also encompasses such backlight unit. The backlight unit is a lighting apparatus arranged on the back-surface side of a liquid crystal panel and configured to illuminate the liquid crystal panel from the back-surface side. The backlight unit may adopt any appropriate configuration. For example, the backlight unit may be of an edge light system, or may be of a direct system. When the direct system is adopted, the backlight unit includes, for example, a light source, a reflective film, a diffuser, and the above-mentioned optical member. When the edge light system is adopted, the backlight unit may further include a light guide plate and a light reflector. The optical member may be arranged on the viewer side of the light source (in the case of the edge light system, the viewer side of the light guide plate). The light source may adopt any appropriate configuration depending on purposes. In one embodiment, the light source is configured to emit light in a blue to ultraviolet region. With such configuration, high brightness and a higher color gamut can be both achieved. A specific configuration of the backlight unit is well known in the art, and hence detailed description thereof is omitted.

I. Liquid Crystal Display Apparatus

According to still another aspect of the present invention, there is provided a liquid crystal display apparatus. In an embodiment in which the optical member does not include a polarizing plate, the liquid crystal display apparatus includes: a liquid crystal cell; a viewer side polarizing plate, which is arranged on the viewer side of the liquid crystal cell; a back-surface side polarizing plate, which is arranged on the opposite side of the liquid crystal cell to the viewer side; the optical member described in the section A to the section G, which is arranged on the outer side of the back-surface side polarizing plate; and a backlight unit, which is arranged on the outer side of the optical member. In an embodiment in which the optical member includes a polarizing plate, the liquid crystal display apparatus includes: a liquid crystal cell; a polarizing plate, which is arranged on the viewer side of the liquid crystal cell; the optical member described in the section A to the section G, which is arranged on the opposite side of the liquid crystal cell to the viewer side; and a backlight unit, which is arranged on the outer side of the optical member. The configuration and driving mode of the liquid crystal cell, and the like are well known in the art, and hence specific description thereof is omitted.

### EXAMPLES

The present invention is specifically described below by way of Examples, but the present invention is not limited to Examples.

### Example 1

(Sheet having Configuration “Barrier Layer/Wavelength Conversion Layer/Barrier Layer”)

100 Parts by weight of polyisobutylene (PIB) serving as a rubber-based polymer was blended with 10 parts by weight of hydrogenated terpene phenol (product name: YS POLYSTER TH130, softening point: 130° C., hydroxyl value: 60, manufactured by Yasuhara Chemical Co., Ltd.) serving as a tackifier, 3 parts by weight of quantum dots, each of which was formed of an InP-based core and had a particle diameter of 10 nm or less and a center emission wavelength of 530 nm, serving as a green wavelength conversion material, and 30 parts by weight of a fluoride phosphor formed of K₂SiF₆:Mn⁴⁺ serving as a red wavelength conversion material, and the solid content was adjusted with a toluene solvent to 18 wt %. Thus, a pressure-sensitive adhesive composition (liquid) containing wavelength conversion materials was prepared.

Meanwhile, a film obtained by subjecting one surface of a PET film having a thickness of 100 μm (product name: COSMOSHINE A4300, manufactured by Toyobo Co., Ltd.) to sputtering treatment with AZO and SiO₂ was used as a barrier layer. The pressure-sensitive adhesive composition obtained above was applied to the sputtering-treated surface of the barrier film with an applicator to form a pressure-sensitive adhesive-applied layer. Then, the applied layer was dried at 120° C. for 3 minutes to form a pressure-sensitive adhesive layer to produce a pressure-sensitive adhesive sheet including a pressure-sensitive adhesive layer having a thickness of 50 μm. Further, the same barrier film as that described above was bonded to the pressure-sensitive adhesive surface of the pressure-sensitive adhesive sheet so that the sputtering-treated surface and the pressure-sensitive adhesive layer were brought into contact with each other. Thus, a sheet having a configuration “barrier layer/pressure-sensitive adhesive layer (wavelength conversion layer)/barrier layer” was obtained.

### (Reflective Polarizer)

A 40-inch TV manufactured by Sharp Corporation (product name: AQUOS, product number: LC40-Z5) was dismantled, and a reflective polarizer was taken out from its backlight member. Diffusing layers arranged on both surfaces of the reflective polarizer were removed, and the remainder was defined as a reflective polarizer of this Example.

### (Production of Polarizing Plate)

A polymer film using polyvinyl alcohol as a main component [manufactured by Kuraray Co., Ltd., product name: “9P75R (thickness: 75 μm, average polymerization degree: 2,400, saponification degree: 99.9 mol %)”] was stretched to 1.2 times in its conveying direction while being immersed in a water bath for 1 minute, and was then stretched to 3 times with reference to a film that had not been stretched at all (original length) in the conveying direction while being dyed by being immersed in an aqueous solution having an iodine concentration of 0.3 wt % for 1 minute. Then, the stretched film was further stretched up to 6 times with reference to the original length in the conveying direction while being immersed in an aqueous solution having a boric acid concentration of 4 wt % and a potassium iodide concentration of 5 wt %. The resultant was dried at 70° C. for 2 minutes to provide a polarizer.

Meanwhile, a colloidal alumina-containing adhesive was applied onto one surface of a triacetylcellulose (TAC) film (manufactured by Konica Minolta, Inc., product name: “KC4UW”, thickness: 40 μm), and the resultant was laminated on one surface of the polarizer obtained above by a roll-to-roll process so that their conveying directions were parallel to each other. The colloidal alumina-containing adhesive was prepared by dissolving 100 parts by weight of a polyvinyl alcohol-based resin having an acetoacetyl group (average polymerization degree: 1,200, saponification degree: 98.5 mol %, acetoacetylation degree: 5 mol %) and 50 parts by weight of methylolmelamine in pure water to prepare an aqueous solution having a solid content of 3.7 wt %, and adding, to 100 parts by weight of the aqueous solution, 18 parts by weight of an aqueous solution containing positively charged colloidal alumina (average particle diameter: 15 nm) at a solid content of 10 wt %. Subsequently, a TAC film having applied thereonto the colloidal alumina-containing adhesive was similarly laminated on the opposite surface of the polarizer by a roll-to-roll process so that their conveying directions were parallel to each other, followed by drying at 55° C. for 6 minutes. Thus, a polarizing plate having a configuration “TAC film/polarizer/TAC film” was obtained.

### (Production of Optical Member)

The polarizing plate obtained above, the reflective polarizer, and the sheet obtained above were bonded to each other via an acrylic pressure-sensitive adhesive to provide an optical member having a configuration “polarizing plate/pressure-sensitive adhesive layer/reflective polarizer/pressure-sensitive adhesive layer/barrier layer/wavelength conversion layer/barrier layer.”

### (Backlight)

LED uniform light-emitting surface lighting (manufactured by Aitec System Co., Ltd., TMN-4 series) was used.

### (Liquid Crystal Panel)

A liquid crystal panel taken out from a 40-inch TV manufactured by Sharp Corporation (product name: AQUOS, product number: LC40-Z5) was used.

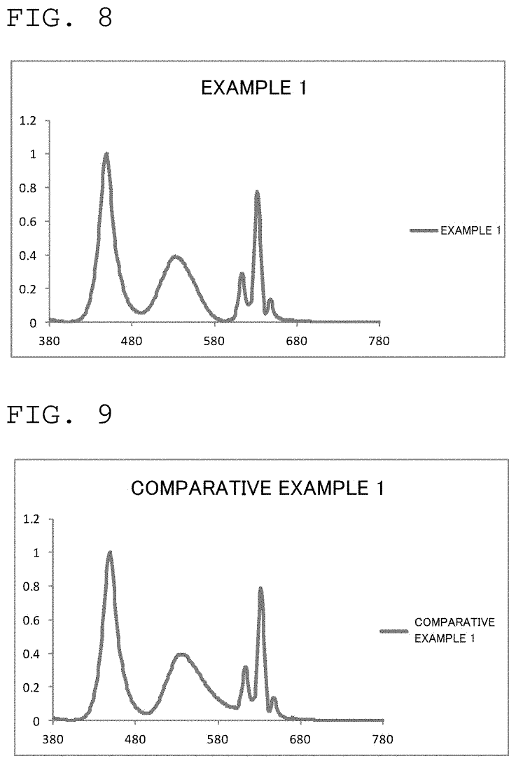

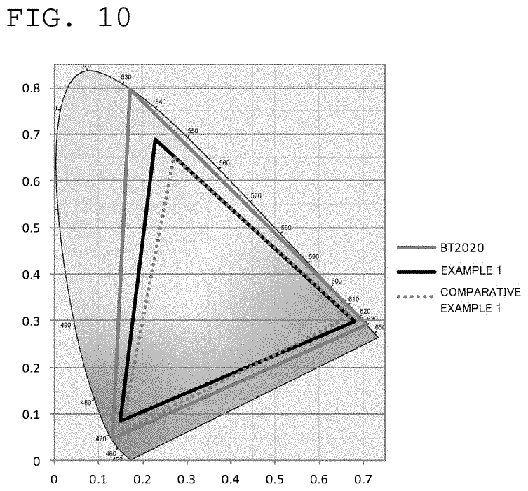

With the use of characteristics equivalent to those of the optical member obtained above, a simulation was performed on the spectrum of light to be extracted from the optical member in the case of using the above-mentioned backlight and liquid crystal panel. More specifically, in the simulation, the chromaticity coordinates (x,y) of each single color (RGB) to be output were calculated by using characteristics actually measured for the light source, the wavelength conversion layer, the backlight, and the liquid crystal panel. A color-matching function was used for the calculation of the chromaticity coordinates. The results are shown in FIG. 8. In the spectrum of FIG. 8, Rp was 0.63, Gp was 0.77, and Ave was 0.06, and hence the expression (1) was satisfied. The results of fitting the spectrum obtained by the simulation into a chromaticity diagram are shown in FIG. 10 together with the results of Comparative Example 1.

### Comparative Example 1

An optical member was obtained in the same manner as in Example except that the sheet having a configuration “barrier layer/wavelength conversion layer/barrier layer” was produced using 5 parts by weight of a Eu-doped SiAlON phosphor as the green wavelength conversion material. A simulation was performed in the same manner as in Example 1 except that the characteristics of the resultant optical member were used. The results are shown in FIG. 9. In the spectrum of FIG. 9, Rp was 0.79, Gp was 0.39, and Ave was 0.13, and hence the expression (1) was not satisfied. The results of fitting the spectrum obtained by the simulation into a chromaticity diagram are shown in FIG. 10 together with the results of Example 1.

<Evaluation>

As is apparent from FIG. 10, it is found that the optical member of Example 1, which satisfies the expression (1), has a wider color gamut than that of Comparative Example 1.

### INDUSTRIAL APPLICABILITY

The optical member of the present invention and the backlight unit using the optical member can be suitably used for a liquid crystal display apparatus. The liquid crystal display apparatus using such optical member and/or backlight unit can be used for various applications, such as portable devices including a personal digital assistant (PDA), a cellular phone, a watch, a digital camera, and a portable gaming machine, OA devices including a personal computer monitor, a notebook-type personal computer, and a copying machine, electric home appliances including a video camera, a liquid crystal television set, and a microwave oven, on-board devices including a reverse monitor, a monitor for a car navigation system, and a car audio, exhibition devices including an information monitor for a commercial store, security devices including a surveillance monitor, and caring/medical devices including a caring monitor and a medical monitor.

### REFERENCE SIGNS LIST

10 wavelength conversion layer
21 barrier layer
22 barrier layer
40 reflective polarizer
50 low-refractive index layer
60 first prism sheet
70 second prism sheet
80 polarizing plate
81 polarizer
100 optical member
101 optical member
102 optical member
103 optical member
104 optical member

1. An optical member, comprising, in the stated order:
a first barrier layer;
a wavelength conversion layer; and
a second barrier layer,
wherein the wavelength conversion layer includes a matrix and a wavelength conversion material dispersed in the matrix, and
wherein an emission spectrum of light to be extracted from the optical member has a peak having an intensity Gp in a wavelength band of from 515 nm to 550 nm, and a peak having an intensity Rp in a wavelength band of from 605 nm to 650 nm, and an average value Ave of intensities in a wavelength band of from 570 nm to 600 nm in the emission spectrum and an average value of Gp and Rp satisfy the following expression (1):
Ave≤0.1×{(Gp+Rp)/2} (1).

2. The optical member according to claim 1, wherein the matrix comprises a resin film.

3. The optical member according to claim 1, wherein the matrix comprises a pressure-sensitive adhesive, and the first barrier layer or the second barrier layer is omitted.

4. The optical member according to claim 1, wherein the wavelength conversion material comprises a first wavelength conversion material having a center emission wavelength in the wavelength band ranging from 515 nm to 550 nm and a second wavelength conversion material having a center emission wavelength in the wavelength band ranging from 605 nm to 650 nm.

5. The optical member according to claim 4, wherein the first wavelength conversion material and the second wavelength conversion material each comprise quantum dots.

6. The optical member according to claim 4, wherein the first wavelength conversion material comprises quantum dots, and the second wavelength conversion material comprises a phosphor.

7. The optical member according to claim 4, wherein the first wavelength conversion material and the second wavelength conversion material each comprise a phosphor.

8. The optical member according to claim 1, further comprising a reflective polarizer on an outer side of the first barrier layer or the second barrier layer.

9. The optical member according to claim 8, further comprising a low-refractive index layer, which has a refractive index of 1.30 or less, between the reflective polarizer and the first barrier layer or the second barrier layer.

10. The optical member according to claim 8, further comprising at least one prism sheet between the reflective polarizer and the first barrier layer or the second barrier layer.

11. The optical member according to claim 8, further comprising a polarizing plate, which includes an absorption-type polarizer, on an opposite side of the reflective polarizer to the first barrier layer or the second barrier layer.

12. A backlight unit, comprising:
a light source; and
the optical member of claim 1, which is arranged on a viewer side of the light source.

13. The backlight unit according to claim 12, wherein the light source is configured to emit light in a blue to ultraviolet region.

14. A liquid crystal display apparatus, comprising:
a liquid crystal cell;
a viewer side polarizing plate, which is arranged on a viewer side of the liquid crystal cell;
a back-surface side polarizing plate, which is arranged on an opposite side of the liquid crystal cell to the viewer side; and
the optical member of claim 1, which is arranged on an outer side of the back-surface side polarizing plate.

15. A liquid crystal display apparatus, comprising:
a liquid crystal cell;
a viewer side polarizing plate, which is arranged on a viewer side of the liquid crystal cell; and
the optical member of claim 11, which is arranged on an opposite side of the liquid crystal cell to the viewer side.

16. An optical member, comprising, in the stated order:
a polarizing plate which includes an absorption-type polarizer;
a reflective polarizer;
a first barrier layer;
a wavelength conversion layer; and
a second barrier layer,
wherein the wavelength conversion layer includes a matrix and a wavelength conversion material dispersed in the matrix, the matrix being a pressure-sensitive adhesive,
wherein the wavelength conversion material comprises a first wavelength conversion material having a center emission wavelength in the wavelength band ranging from 515 nm to 550 nm and a second wavelength conversion material having a center emission wavelength in the wavelength band ranging from 605 nm to 650 nm,
wherein the first wavelength conversion material comprises quantum dots, and the second wavelength conversion material comprises a phosphor, and
wherein an emission spectrum of light to be extracted from the optical member has a peak having an intensity Gp in a wavelength band of from 515 nm to 550 nm, and a peak having an intensity Rp in a wavelength band of from 605 nm to 650 nm, and an average value Ave of intensities in a wavelength band of from 570 nm to 600 nm in the emission spectrum and an average value of Gp and Rp satisfy the following expression (1):
Ave≤0.1×{(Gp+Rp)/2} (1).
